(19) United States
(12) Patent Application Publication
(10) Pub. No.: US 2022/0212706 A1
(43) Pub. Date: Jul. 7, 2022

(54) MOTORIZED STROLLER ASSEMBLY

(71) Applicant: Arlena Jones, Sacramento, CA (US)

(72) Inventor: Arlena Jones, Sacramento, CA (US)

(21) Appl. No.: 17/141,336

(22) Filed: Jan. 5, 2021

(51) Int. Cl. B62B 5/00; B62B 9/14; B60K 1/04; B60L 15/20; B62B 7/04; B62B 9/20

(52) U.S. Cl. CPC B62B 5/0043; B62B 9/142; B60K 1/04; B60L 15/20; B60K 2026/025; B62B 9/20; B62B 5/0053; B62B 5/0069; B60K 2001/0422; B62B 7/04

(57) ABSTRACT

A motorized stroller assembly includes a carriage frame. A plurality of wheels is rotatably attached to the carriage and a child seat is positioned in the carriage frame. An electric motor is mechanically coupled to at least a first wheel of the plurality of wheels. The motor selectively rotates the first wheel to drive the carriage frame forward. A battery is mounted on the carriage frame and is electrically coupled to the motor. A control is mounted on the carriage frame and is electrically coupled to the motor and is actuated to drive the first wheel in the first direction. A platform is attached to a rear side of the carriage and extends rearwardly therefrom. The platform is positioned near a bottom of the carriage. The platform supports a person standing on the platform. A canopy is pivotally coupled to the carriage frame and is extendable over the child seat.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to stroller devices and more particularly pertains to a new stroller device for supporting a parent or other person while a person is transporting a child in the stroller device. Moreover, the stroller device may include a drive assembly to move the stroller device over a ground surface.

### (2) Description of Related Art Including Information Disclosed Under 37 CFR 1.97 and 1.98

The prior art relates to stroller devices that are powered.

### BRIEF SUMMARY OF THE INVENTION

An embodiment of the disclosure meets the needs presented above by generally comprising a carriage frame. A plurality of wheels is rotatably attached to the carriage and a child seat is positioned in the carriage frame. A motor is mechanically coupled to at least a first wheel of the plurality of wheels. The motor is an electric motor and selectively rotates the first wheel in a first direction to drive the carriage frame forward. A battery is mounted on the carriage frame and is electrically coupled to the motor. A control is mounted on the carriage frame and is electrically coupled to the motor and is actuated to drive the first wheel in the first direction. A platform is attached to a rear side of the carriage and extends rearwardly therefrom. The platform is positioned near a bottom of the carriage. The platform supports a person standing on the platform. A canopy is pivotally coupled to the carriage frame and is extendable over the child seat.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a rear isometric view of a motorized stroller assembly according to an embodiment of the disclosure.

FIG. 2 is a front view of an embodiment of the disclosure.

FIG. 3 is a side view of an embodiment of the disclosure.

FIG. 4 is a top view of an embodiment of the disclosure.

FIG. 5 is a bottom view of an embodiment of the disclosure.

FIG. 6 is a side in-use view of an embodiment of the disclosure.

FIG. 7 is a schematic view of an embodiment of the disclosure.

### DETAILED DESCRIPTION OF THE INVENTION

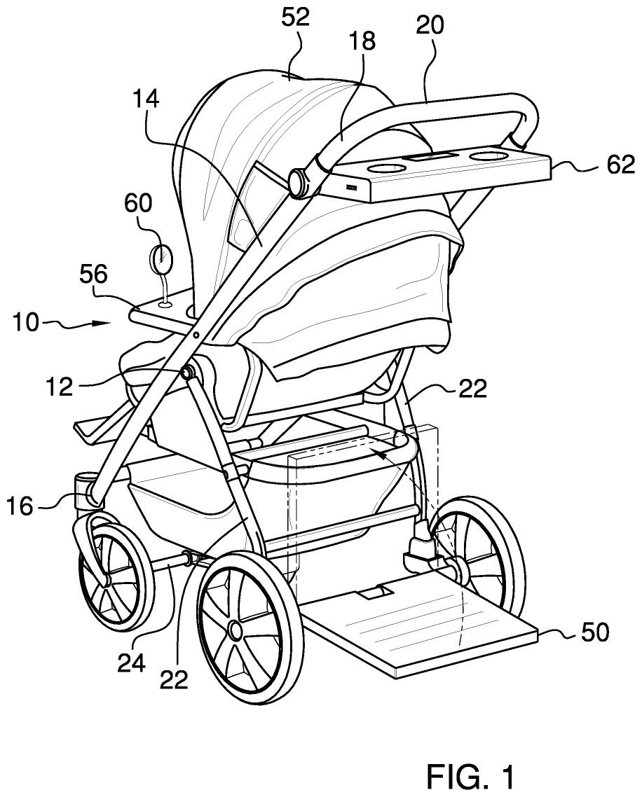

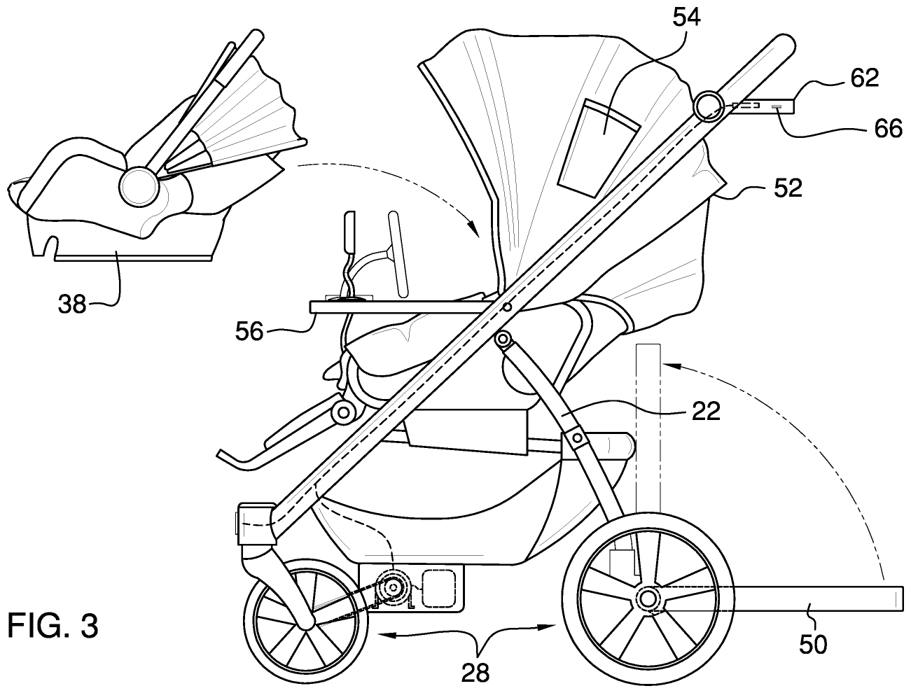

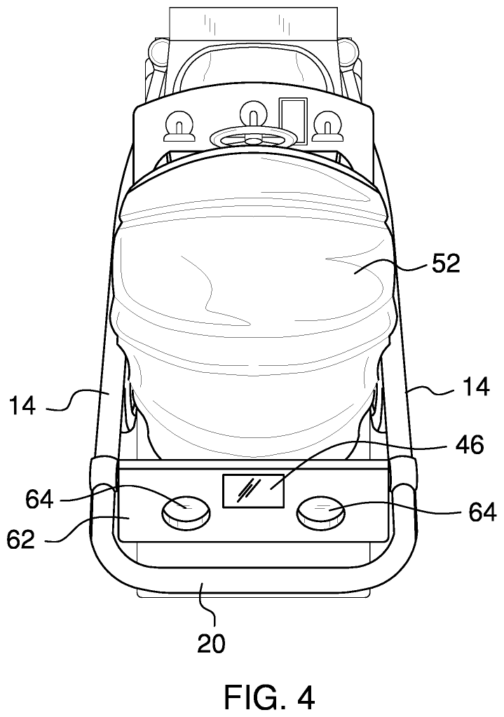

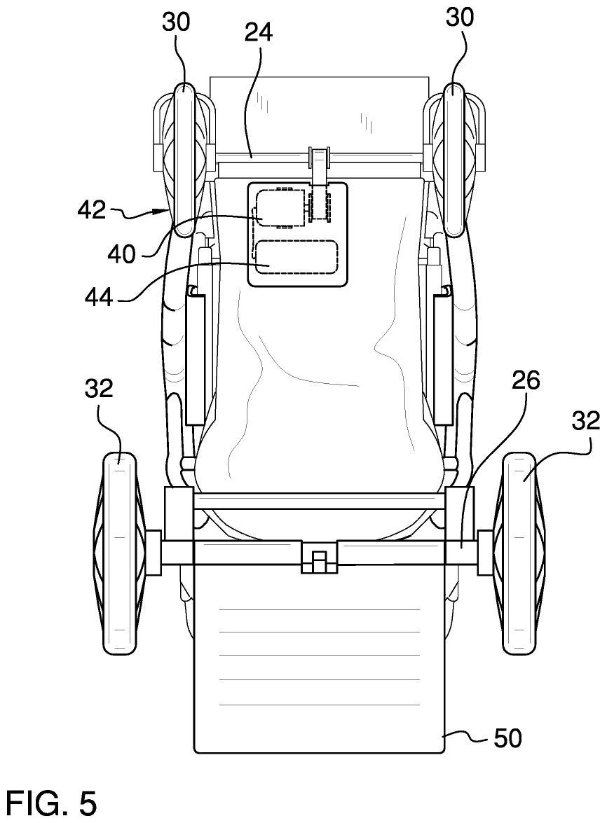

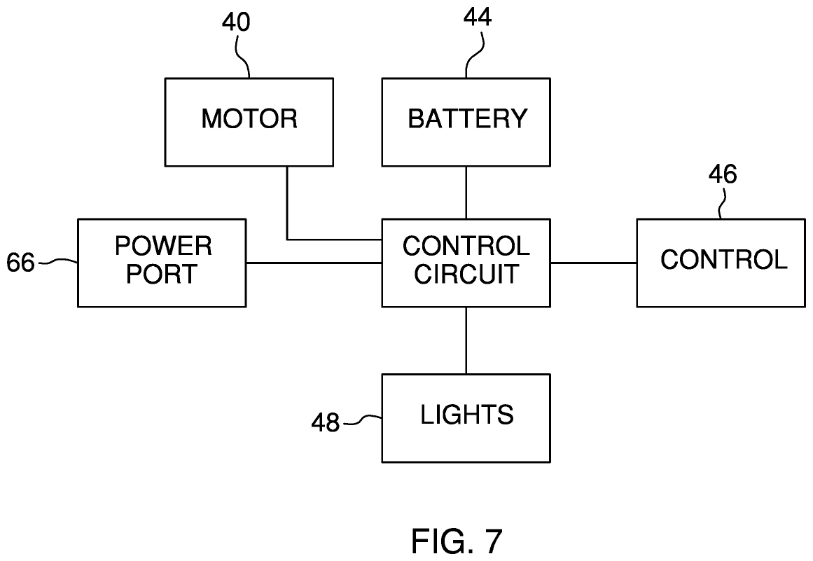

With reference now to the drawings, and in particular to FIGS. 1 through 7 thereof, a new stroller device embodying the principles and concepts of an embodiment of the disclosure and generally designated by the reference numeral 10 will be described.

As best illustrated in FIGS. 1 through 7, the motorized stroller assembly 10 generally comprises a carriage frame 12. The carriage frame 12 is generally conventional to strollers and will typically include a pair of risers 14 each having a lower end 16 and an upper end 18. A grip 20 is attached to and extends between the upper ends 18 of the risers 14. Handles, not shown, may be attached to the grip 20 to facilitate comfort when holding onto the assembly 10. A pair of legs 22 is provided and each of the risers 14 has one of the legs 22 attached thereto at a location between corresponding ones of the upper 18 and lower 16 ends. Each of the legs 22 extends downwardly and rearwardly from the risers 14. A front axle 24 is attached to the carriage frame 12. The front axle 24 extends between the risers 14 adjacent to the lower ends 16. A rear axle 26 is attached to the carriage frame 12 and extends between the legs 22. As with conventional strollers, the legs 22 and risers 14 may be pivotally coupled to each other to allow the carriage frame 12 to be collapsible.

A plurality of wheels 28 is rotatably attached to the carriage frame 12. The wheels 28 include a pair of front wheels 30 rotatably attached to the front axle 24 and a pair of rear wheels 32 is attached to the rear axle 26. However, it should be understood that the carriage frame 12 may not include axles wherein the wheels 28 are attached directly to the risers 14 and legs 22.

A conventional child seat 34 is positioned in the carriage frame 12. The child seat 34 may include a leg support 36 extending outwardly and downwardly from the child seat 34. The child seat 34 may be configured to receive the bottom of an infant carrier 38 such that the assembly 10 is usable both with infants and toddlers.

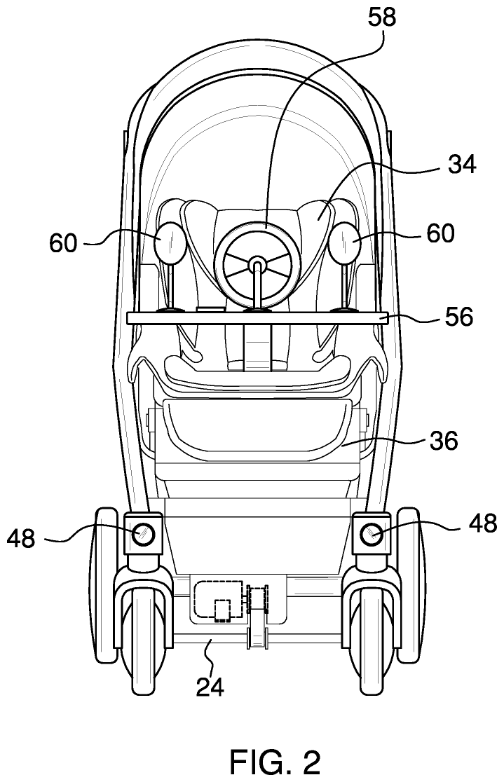

A motor 40 is mechanically coupled to at least a first wheel 42 of the plurality of wheels 28. The motor 40 is an electric motor and is configured to selectively rotate the first wheel 42 in a first direction to drive the carriage frame 12 forward. The motor 40 may be engaged with the front axle 24 such as with a belt as shown in FIG. 2. However, the motor 40 may be mechanically coupled by gears to the front axle 24, be directly in-line with the front axle 24, or directly engaged with the first wheel 42 should the front axle 24 not be utilized. A battery 44 is mounted on the carriage frame 12 and is electrically coupled to the motor 40. The battery 44 is a conventional rechargeable battery used with electric bicycles, electric scooters and the like.

A control 46 is mounted on the carriage frame 12 and is electrically coupled to the motor 40. The control 46 is actuated to drive the first wheel 42 in the first direction. The control 46 may comprise a touch pad, joystick(s), actuator buttons and the like. The assembly 10 may include a pair of electric motors, independently coupled to different ones of the wheels 28, wherein the control 46 can be utilized to drive both or selected ones of the motors 40 to turn the carriage frame 12. The control 46 may further actuate lights 48, mounted on the carriage frame, which are electrically coupled to the battery 44.

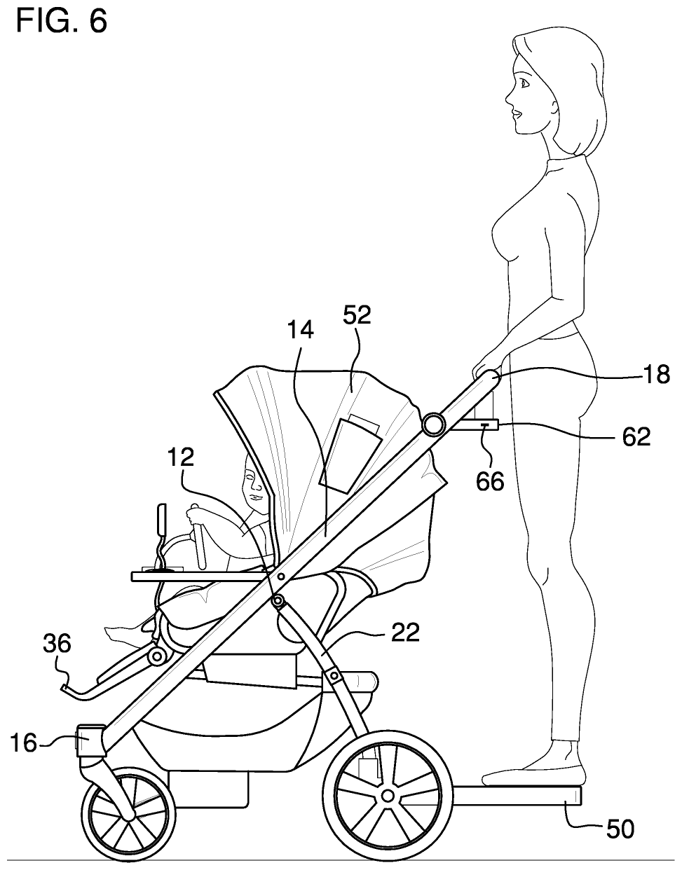

A platform 50 is attached to a rear side of the carriage frame 12 and extends rearwardly therefrom. The platform 50 is positioned near a bottom of the carriage frame 12 and is configured to support a person standing on the platform as shown in FIG. 6. The platform 50 is pivotable upwardly into a stored position such that it does interfere with a person walking while pushing the assembly 10.

A canopy 52 is pivotally coupled to the carriage frame 12. The canopy 52 is extendable over the child seat 34 to shield a child from the elements. One or more pockets 54 are positioned on the canopy 52 to hold various articles such as, for example, cellular phones. Forward of the canopy 52 may be positioned a tray 56 for usage by a child positioned in the child seat 34. The tray 56 may support activity toys such as steering wheels 58, mirrors 60 and other like articles.

A panel 62 is attached to the rear side of the carriage frame 12 adjacent to a top side of the carriage frame and extends rearwardly therefrom. The control 46 may be mounted on the panel 62. The panel 62 may further include at least one drink receptacle 64 positioned therein. A power port 66 is positioned on the panel 62 and the power port 66 is electrically coupled to the battery 44. The power port 66 may be used not only for recharging the battery 44 but may also be used for charging small electrics from the battery 44.

In use, the assembly 10 is used in a conventional manner to hold a child so that a parent can push the child as the child rides in the child seat 34. However, the platform 50 is usable by a parent or other person to ride on the assembly 10 while the electric motor 40 moves the carriage frame 12 across a floor surface.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A motorized stroller assembly comprising:
a carriage frame;
a plurality of wheels being rotatably attached to the carriage frame;
a child seat being positioned in the carriage frame;
a motor being mechanically coupled to at least a first wheel of the plurality of wheels, the motor being an electric motor and being configured to selectively rotate the first wheel in a first direction to drive the carriage frame forward;
a battery being mounted on the carriage frame and being electrically coupled to the motor;
a control being mounted on the carriage frame and being electrically coupled to the motor, the control being actuated to drive the first wheel in the first direction;
a platform being attached to a rear side of the carriage frame and extending rearwardly therefrom, the platform being positioned near a bottom of the carriage frame, the platform being configured to support a person standing on the platform; and
a canopy being pivotally coupled to the carriage frame, the canopy being extendable over the child seat.

2. The motorized stroller assembly according to claim 1, wherein the carriage frame includes:
a pair of risers each having a lower end and an upper end;
a grip being attached to and extending between the upper ends of the risers;
a pair of legs, each of the risers having one of the legs attached thereto between corresponding ones of the upper and lower ends, each of the legs extending downwardly and rearwardly from the risers;
a front axle being attached to the carriage frame, the front axle extending between the risers adjacent to the lower ends;
a rear axle being attached to the carriage frame, the rear axle and extending between the legs.

3. The motorized stroller assembly according to claim 2, wherein the plurality of wheels includes:
a pair of front wheels being rotatably attached to the front axle; and
a pair of rear wheels being attached to the rear axle.

4. The motorized stroller assembly according to claim 3, wherein the motor is engaged with the front axle.

5. The motorized stroller assembly according to claim 1, further including the platform being pivotable upwardly into a stored position.

6. The motorized stroller assembly according to claim 1, further including a panel being attached to the rear side of the carriage frame adjacent to a top side of the carriage frame and extending rearwardly therefrom, the control being mounted on the panel.

7. The motorized stroller assembly according to claim 6, wherein the panel has at least one drink receptacle positioned therein.

8. The motorized stroller assembly according to claim 6, further including a power port being positioned on the panel, the power port being electrically coupled to the battery.

9. A motorized stroller assembly comprising:
a carriage frame, the carriage frame including:
a pair of risers each having a lower end and an upper end;
a grip being attached to and extending between the upper ends of the risers;
a pair of legs, each of the risers having one of the legs attached thereto between corresponding ones of the upper and lower ends, each of the legs extending downwardly and rearwardly from the risers;
a front axle being attached to the carriage frame, the front axle extending between the risers adjacent to the lower ends;
a rear axle being attached to the carriage frame, the rear axle and extending between the legs;
a plurality of wheels being rotatably attached to the carriage frame, the wheels including:
a pair of front wheels being rotatably attached to the front axle;
a pair of rear wheels being attached to the rear axle;
a child seat being positioned in the carriage frame;
a motor being mechanically coupled to at least a first wheel of the plurality of wheels, the motor being an electric motor and being configured to selectively rotate the first wheel in a first direction to drive the carriage frame forward, the motor being engaged with the front axle;
a battery being mounted on the carriage frame and being electrically coupled to the motor;
a control being mounted on the carriage frame and being electrically coupled to the motor, the control being actuated to drive the first wheel in the first direction;
a platform being attached to a rear side of the carriage frame and extending rearwardly therefrom, the platform being positioned near a bottom of the carriage, the platform being configured to support a person standing on the platform, the platform being pivotable upwardly into a stored position;
a canopy being pivotally coupled to the carriage frame, the canopy being extendable over the child seat;
a panel being attached to the rear side of the carriage frame adjacent to a top side of the carriage frame and extending rearwardly therefrom, the control being mounted on the panel, the panel having at least one drink receptacle positioned therein; and
a power port being positioned on the panel, the power port being electrically coupled to the battery.
